(19) United States
(12) Patent Application Publication
(10) Pub. No.: US 2002/0114382 A1
(43) Pub. Date: Aug. 22, 2002

(54) Parallel optimal data rate setting in a modem pool environment

(76) Inventors: Dan Goren, Ramat Gan (IL); Amir Kantschuk, Ramat Gan (IL)

Correspondence Address: Eitan, Pearl, Latzer & Cohen-Zedek, One Crystal Park, Suite 210, 2011 Crystal Drive, Arlington, VA, 22202-3709, US

(21) Appl. No.: 09/849,408

(22) Filed: May 7, 2001

Related U.S. Application Data
(60) Provisional application No. 60/253,712, filed on Nov. 29, 2000.

(51) Int. Cl. H04L 23/00; H04L 5/16; H04B 1/38

(52) U.S. Cl. 375/222; 375/377

(57) ABSTRACT

A method of parallel data rate setting for first and second modem pools, each modem pool including a plurality of modems, where each modem in one of the modem pools is paired with a corresponding modem in the other of the modem pools, including setting substantially in parallel each of the modem pairs to an initial data rate, for each of the modem pairs, performing the following steps one or more times until a termination condition is met: if the modem pair is synchronized within a synchronization time period, increasing the modem pair's data rate, if the modem pair is not synchronized within the synchronization time period, decreasing the modem pair's data rate, and setting each of the modem pairs to the highest data rate at which the modem pair achieved synchronization.

### RELATED APPLICATIONS

This application claims priority from U.S. Provisional Patent Application, Ser. No. 60/253,712 entitled: Parallel Optimal Data Rate Setting in a Modem Pool Environment, filed on Nov. 29, 2000, and this Provisional Patent Application Ser. No. 60/253,712 is incorporated by reference in its entirety herein.

### FIELD OF THE INVENTION

The present invention is related to telecommunications systems in general, and more particularly to optimal modem data rate setting in a modem pool environment.

### BACKGROUND OF THE INVENTION

The ever-increasing demand for high-speed data communications services and greater bandwidth is largely due to the popularity of the Internet and other data-intensive, high bandwidth applications. Both businesses and consumers are demanding higher bandwidth connections and faster Internet access. Another source for this demand is the increasing use by businesses of data communications networks, most notably the Internet, for the transmission of documents and electronic mail.

Digital Subscriber Line (DSL) technology provides one approach to addressing the demand for high-speed telecommunications service. DSL technology refers to several types of services that use advanced modem elements to transmit digital signals from a data source over copper wires. Many telephone companies have embraced DSL technology as an immediate broadband solution to serve the current demand by getting more out of their existing copper infrastructure. DSL modem elements permit high data rate transmission of data over the access segment of the public switched telephone network (PSTN) at multiple megabit speeds using sophisticated signal processing techniques that permit voice and data to travel simultaneously over the same analog copper twisted pair wire.

For even greater data transmission rates, several DSL modems may be arranged in a modem pool where a data stream is demultiplexed and transmitted via each of the modems in the modem pool. In such an arrangement, one modem might optimally transmit data at a higher data rate than another modem. However, conventional approaches to setting modem data rates in a modem pool environment include setting all modems to the same pre-defined data rate, or setting modem data rates individually according to a pre-defined data rates array. In either case the pre-defined data rate is typically set according to a preset value or based on loop length. Such approaches are inherently non-optimizing.

### SUMMARY OF THE INVENTION

The present invention seeks to provide a new approach to setting modem data rates in a modem pool environment that achieves an optimal date rate in minimal time for each modem using an adaptive technique. The present invention may be implemented by a single processor for all the modems in a modem pool, without the need for a dedicated processor at each modem. This approach may be applied to modems in a modem pool where there is little or no near-end cross talk (NEXT) by nature, or where there is little or no NEXT due to the implementation of NEXT cancellation techniques.

In one aspect of the present invention a method of parallel data rate setting is provided for first and second modem pools, each modem pool including a plurality of modems, where each modem in one of the modem pools is paired with a corresponding modem in the other of the modem pools, the method including the steps of a) setting substantially in parallel each of the modem pairs to an initial data rate, for each of the modem pairs b) performing the following steps c)-d) one or more times until a termination condition is met c) if the modem pair is synchronized within a synchronization time period, increasing the modem pair's data rate, d) if the modem pair is not synchronized within the synchronization time period, decreasing the modem pair's data rate, and e) setting each of the modem pairs to the highest data rate at which the modem pair achieved synchronization.

In another aspect of the present invention the method further includes establishing a vector of initial data rates, where each of the data rates corresponds to a different one of the modem pairs, and where the setting step a) includes setting each of the modem pairs to its corresponding initial data rate in the vector.

In another aspect of the present invention the establishing step includes establishing the vector at one of the modem pools and communicating the vector to the other of the modem pools.

In another aspect of the present invention the establishing step includes establishing the vector from data rates previously used by the modem pairs.

In another aspect of the present invention the establishing step includes measuring wire attenuation for any of the modem pairs, and interpolating the corresponding data rate from the wire attenuation using heuristics.

In another aspect of the present invention the establishing step includes measuring SNR for any of the modem pairs, and interpolating the corresponding data rate from the SNR using heuristics.

In another aspect of the present invention the performing step b) includes incrementing an iteration counter and the termination condition is met when the iteration counter reaches an iteration limit.

In another aspect of the present invention the performing step b) includes performing until an elapsed time limit is reached.

In another aspect of the present invention the performing step b) includes performing until there is no change in the data rates from a previous iteration of step b).

In another aspect of the present invention the method further includes adjusting the highest data rate for any of the modem pairs according to the formula

$${Rate}_{Corrected} = {Rate}_{max} - StabilityFactor * \frac{{SNR}_{Re f} - SNR}{{SNR}_{Re f}} where {Rate}_{max}$$

$$is the highest data rate , StabilityFactor is any factor for step$$

$$adjustment , SNR is the measured SNR of the modem pair , \\ and {SNR}_{Ref} is any SNR value .$$

In another aspect of the present invention the adjusting step includes using the minimum SNR of the modem pair where the SNR differs for each of the modems in the modem pair.

In another aspect of the present invention a method of parallel data rate setting is provided for first and second modem pools, each modem pool including a plurality of modems, where each modem in one of the modem pools is paired with a corresponding modem in the other of the modem pools, the method including the steps of a) establishing a vector of initial data rates, where each of the data rates corresponds to a different one of the modem pairs, b) setting substantially in parallel each of the modem pairs to the modem pair's corresponding data rate in the vector, c) setting a lower rate for each of the modem pairs that is less than or equal to the modem pair's initial data rate, d) setting an upper rate for each of the modem pairs that is greater than or equal to the modem pair's initial data rate, for each of the modem pairs e) performing the following steps f)-j) one or more times until a termination condition is met f) if the modem pair is synchronized within a synchronization time period g) setting a lower rate for the modem pair equal to the current data rate of the modem pair, and h) setting a maximum rate for the modem pair equal to the current data rate of the modem pair, i) if the modem pair is not synchronized within the synchronization time period, setting a higher rate for the modem pair equal to the current data rate of the modem pair, j) setting the modem pair's corresponding data rate in the vector to between the lower rate and the higher rate, and k) setting each of the modem pairs to the modem pair's maximum rate where the modem pair achieved synchronization at the maximum rate.

In another aspect of the present invention the establishing step includes establishing the vector at one of the modem pools and communicating the vector to the other of the modem pools

In another aspect of the present invention the establishing step includes establishing the vector from data rates previously used by the modem pairs.

In another aspect of the present invention the establishing step includes measuring wire attenuation for any of the modem pairs, and interpolating the corresponding data rate from the wire attenuation using heuristics.

In another aspect of the present invention the establishing step includes measuring SNR for any of the modem pairs, and interpolating the corresponding data rate from the SNR using heuristics.

In another aspect of the present invention the performing step e) includes incrementing an iteration counter and the termination condition is met when the iteration counter reaches an iteration limit.

In another aspect of the present invention the performing step e) includes performing until an elapsed time limit is reached.

In another aspect of the present invention the performing step e) includes performing until there is no change in the data rates from a previous iteration of step e).

In another aspect of the present invention the method further includes adjusting the highest data rate for any of the modem pairs according to the formula

$${Rate}_{Corrected} = {Rate}_{max} - StabilityFactor * \frac{{SNR}_{Re f} - SNR}{{SNR}_{Re f}} where {Rate}_{max}$$

$$is the highest data rate , StabilityFactor is any factor for step$$

$$adjustment , SNR is the measured SNR of the modem pair , \\ and {SNR}_{Ref} is any SNR value .$$

In another aspect of the present invention a data communications system is provided including a first and a second modem pool, each modem pool including a plurality of modems, where each modem in one of the modem pools is paired with a corresponding modem in the other of the modem pools, and a parallel data rate setter operative to a) set substantially in parallel each of the modem pairs to an initial data rate, for each of the modem pairs b) perform the following steps c)-d) one or more times until a termination condition is met c) if the modem pair is synchronized within a synchronization time period, increase the modem pair's data rate, d) if the modem pair is not synchronized within the synchronization time period, decrease the modem pair's data rate, and e) set each of the modem pairs to the highest data rate at which the modem pair achieved synchronization.

In another aspect of the present invention the parallel data rate setter is additionally operative to establish a vector of initial data rates, where each of the data rates corresponds to a different one of the modem pairs, and set each of the modem pairs to its corresponding initial data rate in the vector.

In another aspect of the present invention the parallel data rate setter is additionally operative to establish the vector at one of the modem pools and communicate the vector to the other of the modem pools.

In another aspect of the present invention the parallel data rate setter is additionally operative to establish the vector from data rates previously used by the modem pairs.

In another aspect of the present invention the parallel data rate setter is additionally operative to measure wire attenuation for any of the modem pairs, and interpolate the corresponding data rate from the wire attenuation using heuristics.

In another aspect of the present invention the parallel data rate setter is additionally operative to measure SNR for any of the modem pairs, and interpolate the corresponding data rate from the SNR using heuristics.

In another aspect of the present invention the parallel data rate setter is additionally operative to increment an iteration counter and where the termination condition is met when the iteration counter reaches an iteration limit.

In another aspect of the present invention the parallel data rate setter is additionally operative to perform step b) until an elapsed time limit is reached.

In another aspect of the present invention the parallel data rate setter is additionally operative to perform step b) until there is no change in the data rates from a previous iteration of step b).

In another aspect of the present invention the parallel data rate setter is additionally operative to adjust the highest data rate for any of the modem pairs according to the formula

$${Rate}_{Corrected} = {Rate}_{max} - StabilityFactor * \frac{{SNR}_{Re f} - SNR}{{SNR}_{Re f}}$$

where Rate_{Max} is the highest data rate, StabilityFactor is any factor for step adjustment, SNR is the measured SNR of the modem pair, and SNR_{Ref} is any SNR value.

In another aspect of the present invention the parallel data rate setter is additionally operative to adjust using the minimum SNR of the modem pair where the SNR differs for each of the modems in the modem pair.

In another aspect of the present invention a data communications system is provided including a first and a second modem pool, each modem pool including a plurality of modems, where each modem in one of the modem pools is paired with a corresponding modem in the other of the modem pools, and a parallel data rate setter operative to a) establish a vector of initial data rates, where each of the data rates corresponds to a different one of the modem pairs, b) set substantially in parallel each of the modem pairs to the modem pair's corresponding data rate in the vector, c) set a lower rate for each of the modem pairs that is less than or equal to the modem pair's initial data rate, d) set an upper rate for each of the modem pairs that is greater than or equal to the modem pair's initial data rate, for each of the modem pairs e) perform the following steps f)-j) one or more times until a termination condition is met f) if the modem pair is synchronized within a synchronization time period g) set a lower rate for the modem pair equal to the current data rate of the modem pair, and h) set a maximum rate for the modem pair equal to the current data rate of the modem pair, i) if the modem pair is not synchronized within the synchronization time period, set a higher rate for the modem pair equal to the current data rate of the modem pair, j) set the modem pair's corresponding data rate in the vector to between the lower rate and the higher rate, and k) set each of the modem pairs to the modem pair's maximum rate where the modem pair achieved synchronization at the maximum rate.

In another aspect of the present invention the parallel data rate setter is additionally operative to establish the vector at one of the modem pools and communicate the vector to the other of the modem pools.

In another aspect of the present invention the parallel data rate setter is additionally operative to establish the vector from data rates previously used by the modem pairs.

In another aspect of the present invention the parallel data rate setter is additionally operative to measure wire attenuation for any of the modem pairs, and interpolate the corresponding data rate from the wire attenuation using heuristics.

In another aspect of the present invention the parallel data rate setter is additionally operative to measure SNR for any of the modem pairs, and interpolate the corresponding data rate from the SNR using heuristics.

In another aspect of the present invention the parallel data rate setter is additionally operative to increment an iteration counter and where the termination condition is met when the iteration counter reaches an iteration limit.

In another aspect of the present invention the parallel data rate setter is additionally operative to perform step e) until an elapsed time limit is reached.

In another aspect of the present invention the parallel data rate setter is additionally operative to perform step e) until there is no change in the data rates from a previous iteration of step e).

In another aspect of the present invention the parallel data rate setter is additionally operative to adjust the highest data rate for any of the modem pairs according to the formula

$${Rate}_{Corrected} = {Rate}_{max} - StabilityFactor * \frac{{SNR}_{Re f} - SNR}{{SNR}_{Re f}}$$

where Rate_{Max} is the highest data rate, StabilityFactor is any factor for step adjustment, SNR is the measured SNR of the modem pair, and SNR_{Ref} is any SNR value.

### BRIEF DESCRIPTION OF THE DRAWINGS

The present invention will be understood and appreciated more filly from the following detailed description taken in conjunction with the appended drawings in which:

FIG. 1 is a conceptual illustration of a modem pool arrangement, useful in understanding the present invention;

FIG. 2 is a flowchart illustration of a method of parallel data rate setting in a modem pool environment, operative in accordance with a preferred embodiment of the present invention; and

FIG. 3 is a flowchart illustration of a method of data rate adaptation, operative in accordance with a preferred embodiment of the present invention.

### DETAILED DESCRIPTION OF PREFERRED EMBODIMENTS

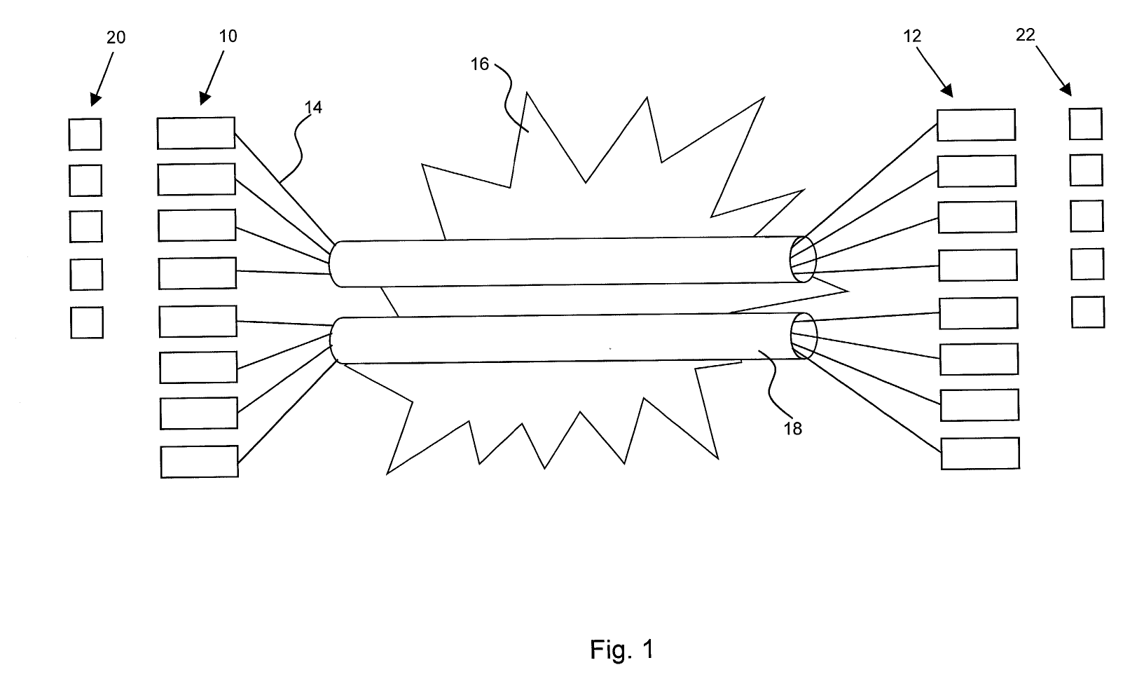

Reference is now made to FIG. 1 which is a conceptual illustration of a modem pool arrangement useful in understanding the present invention. A first modem pool, generally referenced 10, and comprising a plurality of individual modems is seen in communication with a second modem pool, generally referenced 12, via a plurality of connections 14 over a telephone network 16. Connections 14 are typically copper wire pairs arranged in one or more bundles 18. Modem pools 10 and 12 typically operate from central office (CO) and remote terminal (RT) locations respectively, and are alternatively referred to herein as CO 10 and RT 12. The modem pools preferably operate in a coordinated manner, such as is described in Applicant/assignee's U.S. patent application Ser. No. 09/510,550 filed Feb. 22, 2000, and entitled “High Speed Access System Over Copper Cable Plant,” that claims priority from U.S. Provisional Application Ser. No. 60/121,228, filed Feb. 23, 1999, and entitled “Access Express-Very High Data Rate Communication Channels Over Copper,” both hereby incorporated by reference in their entirety.

Each modem pool in FIG. 1 typically includes one or more NEXT cancellation filters 20 and 22 respectively, canceling the NEXT interference from one or more disturbing modems in the same modem pool using any known technique including that which is described in Applicant/assignee's U.S. patent application Ser. No. 09/643,821, the disclosure of which is incorporated herein by reference in its entirety.

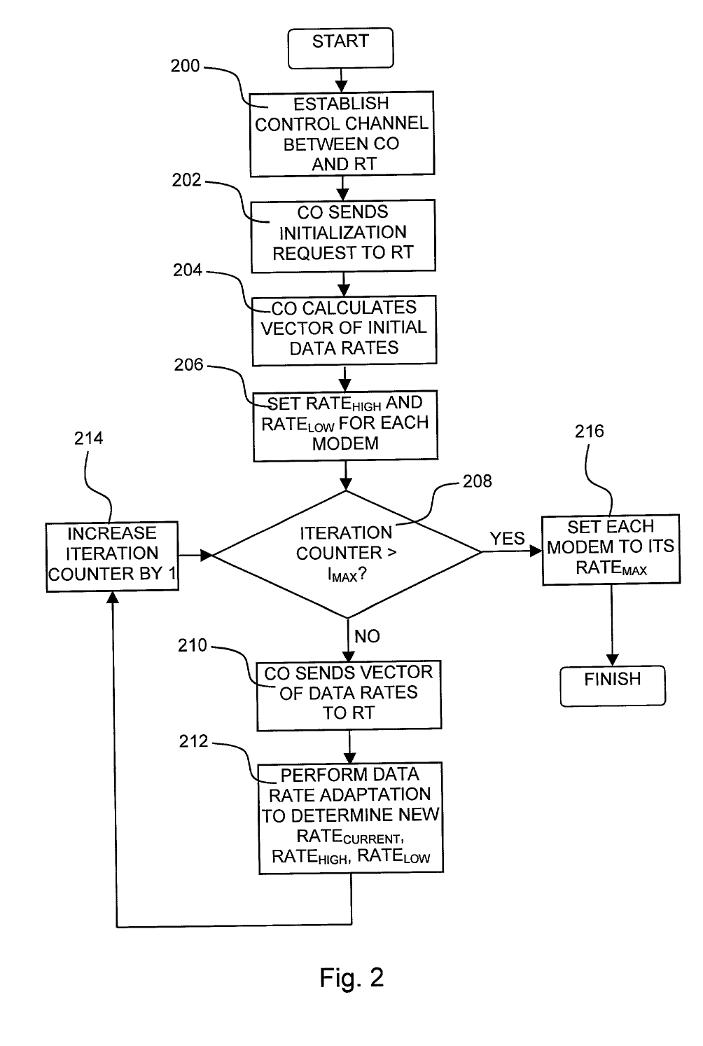

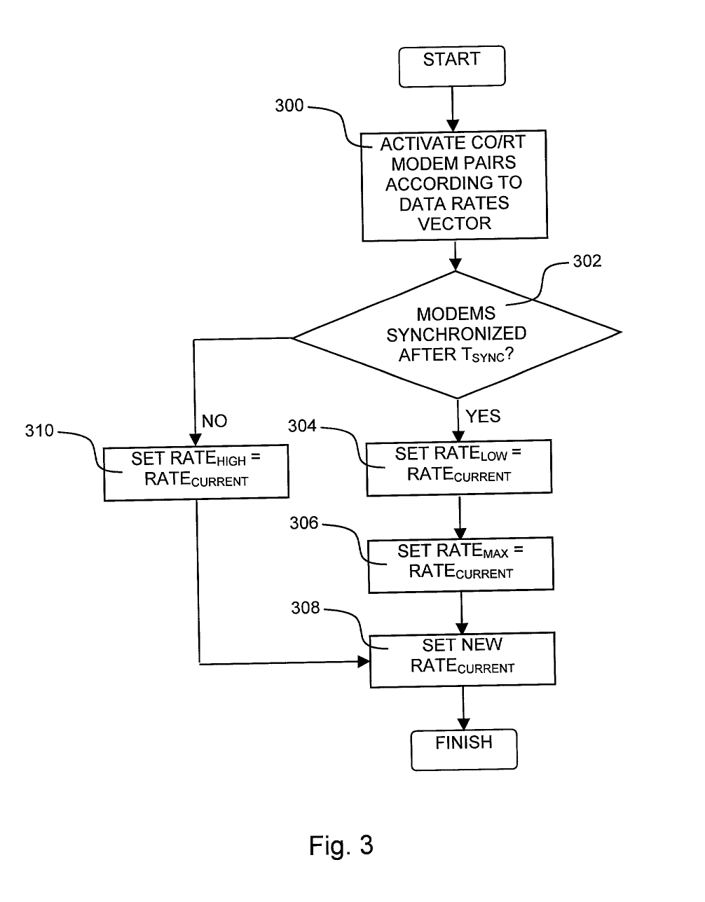

Reference is now made to FIG. 2, which is a flowchart illustration of a method of parallel data rate setting in a modem pool environment, operative in accordance with a preferred embodiment of the present invention. In the method of FIG. 2, CO 10 is preferably configured to perform parallel data rate setting as follows. A control channel is established between one or more modems in CO 10 and one or more modems in RT 12, typically at their minimum data transmission rate (step 200). Once the control channel is established, CO 10 preferably sends an initialization request to RT 12 to indicate that the present data rate setting method is to be carried out (step 202). CO 10 then establishes a vector of initial data rates, denoted Rate_{current} indicating the data rate at which to set each CO/RT modem pair, defined as a CO 10 modem that is to communicate with an RT 12 modem (step 204). The vector may be constructed based on previously used data rates for the modems of CO 10 and RT 12 that provided a reasonably consistent bit error rate (BER) and signal-to-noise ratio (SNR) for each modem. Alternatively, the initial data rates vector may be determined by measuring wire attenuation and/or SNR on the links between the modems of CO 10 and RT 12 using conventional means and interpolating the data rate using heuristics, such by using a look-up table. The initial data rates vector may also be determined using prior knowledge of wire transmission parameters supplied by the telephone company, or through any other known means. Where the initial data rates vector is determined based on physical measurements, it is preferable that one or more, and preferably all, of the modems in CO 10 and RT 12 perform the same type of measurements. Where such measurements are performed by only one of the modem pools CO 10 and RT 12 that does not perform the methods of FIGS. 2 and 3, the modem pool that performs the measurements should convey the results to the other modem pool that performs the methods of FIGS. 2 and 3, typically via the control channel, in support of calculating the initial data rates array.

In addition to the initial data rates vector, CO 10 preferably maintains upper and lower data rates for each modem, referred to herein as Rate_{High} and Rate_{Low} respectively (step 206). The upper and lower data rates are typically set to pre-defined values or may be determined using any conventional technique. Typically, each upper data rate is set greater than or equal to the modem's initial date rate, and preferably the maximum (i.e., ceiling) data rate that is supported by the modem, and each lower data rate is set less than or equal to the modem's initial date rate, and preferably the minimum (i.e., floor) data rate that is supported by the modem. Where two modems in a modem pair have different minimum and maximum rates, the highest minimum and lowest maximum rates are used.

CO 10 typically maintains an iteration counter that is reset each time the method of FIG. 2 is carried out and that has a pre-defined iteration limit, denoted Iₘₐₓ, that may be used to determine when the method of FIG. 2 is to be terminated. After the modems have been set to the data rates indicated in the vector, CO 10 checks the iteration counter to determine if it has reached the iteration limit (step 208). Additionally or alternatively, CO 10 may check for any other pre-defined condition for terminating the method of FIG. 2, such as an elapsed time from initiation of the method of FIG. 2. Additionally or alternatively, CO 10 may identify that a termination condition is met when there is no change in the current modem rates between iterations.

If the iteration counter has not reached the iteration limit Iₘₐₓ, and/or if no other termination condition is met, CO 10 then sends the data rates vector to RT 12 (step 210). Data rate adaptation is then performed using the method described in greater detail hereinbelow with reference to FIG. 3 to determine new values for Rate_{Current}, Rate_{High}, and Rate_{Low} (step 212). At the completion of the data rate adaptation phase the iteration counter is increased by 1 (step 214). Steps 208-214 may be repeated as long as the iteration limit Iₘₐₓ is not reached and/or if no other termination condition is met.

Once the iteration counter reaches the iteration limit Iₘₐₓ, and/or if another termination condition is met, CO 10 and RT 12 set their modems to the maximum operative data rate, referred to herein as Rate_{Max}, found for each modem during the data rate adaptation phase of FIG. 3 (step 216). Thus, the optimal rate search of the present method may be terminated at any stage by using Iₘₐₓ or other termination indicator, while yielding a valid solution and a “local” optimum result, as indicated by Rate_{Max}.

When setting each modem to its Rate_{Max}, a performance margin may optionally be set for the modem such that a certain amount of deterioration in the environmental conditions of the modem, usually manifested as a decrease in modem SNR, will not cause the modem to lose synchronization. For example, the following correction may be applied to Rate_{Max}.

$${Rate}_{Corrected} = {Rate}_{max} - StabilityFactor * \frac{{SNR}_{Re f} - SNR}{{SNR}_{Re f}}$$

where StabilityFactor is a user-defined or other pre-defined factor for step adjustment, SNR is the measured modem SNR, and SNR_{Ref} is a user-defined or other pre-defined SNR value. For example, if the modem SNR is 20 dB, the SNR_{Ref} and StabilityFactor may be set to 25 dB and 5 respectively, and the Rate_{Corrected} may be set to Rate_{Max}−1, increasing the modem SNR and the modem performance margin. The modem SNR value may be determined using any conventional technique, such as by using the modem's internal SNR meter. Where the SNR is different for each modem in a modem pair, the minimum SNR for the modem pair is preferably chosen.

Reference is now made to FIG. 3, which is a flowchart illustration of a method of data rate adaptation, operative in accordance with a preferred embodiment of the present invention. The steps of the method of FIG. 3 are preferably carried out concurrently for one or more, and preferably all, of CO/RT modem pairs in CO 10 and RT 12. In the method of FIG. 3, each CO/RT modem pair is activated at the Rate_{current} data rate indicated for the modems in the data rates vector (step 300). This activation is preferably carried out in parallel for all modem pairs. During a pre-defined synchronization time period T_{sync}, each modem pair attempts to achieve link synchronization. Once T_{sync} has elapsed, each modem pair is checked for synchronization (step 302).

For each modem pair, if the modem pair achieved synchronization, Rate_{Low} is set to the current modem data rate (step 304) and Rate_{High} is unchanged. Referring again to the iteration counter of the method of FIG. 2, the iteration counter of the current iteration may be denoted as i, and the data rate variables are set as follows:

$${Rate}_{High}^{( i + 1 )} = {Rate}_{High}^{( i )}$$

$${Rate}_{Low}^{( i + 1 )} = {Rate}_{Current}^{( i )}$$

where Rate⁽ⁱ⁾_{Current} is the current modem rate.

A maximum effective data rate, Rate_{Max}, is also preferably maintained at CO 10 and is set to the current data rate, Rate⁽ⁱ⁾_{Current} (step 306).

If the modem pair did not achieve synchronization, Rate_{High} is set to the current modem data rate (step 310) and Rate_{Low} is unchanged. The data rate variables are set as follows:

$${Rate}_{High}^{( i + 1 )} = {Rate}_{Current}^{( i )}$$

$${Rate}_{Low}^{( i + 1 )} = {Rate}_{Low}^{( i )}$$

where Rate⁽ⁱ⁾_{Current} is the current modem rate. Rate_{Max} is also preferably unchanged.

After either of steps 306 and 310, a new current modem data rate Rate⁽ⁱ⁺¹⁾_{Current} is determined for the next iteration i+1 for each of the modem pairs in the data rates vector. The new current modem data rate is preferably set for those modem pairs that achieved synchronization at a rate that is greater than the Rate⁽ⁱ⁾_{Current} of the modem pair, and for those modem pairs that did not achieve synchronization at a rate that is less than the Rate⁽ⁱ⁾_{Current} of the modem pair (step 308). Such a new current modem data rate may be determined according to the following formula:

$${Rate}_{Current}^{( i + 1 )} = \frac{{Rate}_{High}^{( i + 1 )} + {Rate}_{Low}^{( i + 1 )}}{2} .$$

The methods of FIGS. 2 and 3, and in particular the use of a control channel for sending the data rates vector and other measurements to RT 12, are typically applied where RT 12 modems are incapable of automatically setting their data rates to match the detected data rates of corresponding CO 10 modems. Where RT 12 modems are capable of automatically setting their data rates in this manner, the methods of FIGS. 2 and 3 may be applied to the modems of CO 10 only, without need for the described control channel.

It is appreciated that any of the methods described herein regarding CO 10 may be applied to RT 12, and that any of the methods described herein regarding RT 12 may be applied to CO 10.

It is appreciated that one or more of the steps of any of the methods described herein may be omitted or carried out in a different order than that shown, without departing from the true spirit and scope of the invention.

It is appreciated that the methods and apparatus described herein may be implemented using computer hardware and/or software using conventional techniques.

While the present invention has been described with reference to one or more specific embodiments, the description is intended to be illustrative of the invention as a whole, and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method of parallel data rate setting in first and second modem pools, each modem pool including a plurality of modems, where each modem in one of said modem pools is paired with a corresponding modem in the other of said modem pools, the method comprising the steps of:
a) setting substantially in parallel each of said modem pairs to an initial data rate;
for each of said modem pairs:
b) performing the following steps c)-d) one or more times until a termination condition is met:
c) if said modem pair is synchronized within a synchronization time period, increasing said modem pair's data rate;
d) if said modem pair is not synchronized within said synchronization time period, decreasing said modem pair's data rate; and
e) setting each of said modem pairs to the highest data rate at which said modem pair achieved synchronization.

2. A method according to claim 1 and further comprising establishing a vector of initial data rates, wherein each of said data rates corresponds to a different one of said modem pairs, and wherein said setting step a) comprises setting each of said modem pairs to its corresponding initial data rate in said vector.

3. A method according to claim 2 wherein said establishing step comprises establishing said vector at one of said modem pools and communicating said vector to the other of said modem pools.

4. A method according to claim 2 wherein said establishing step comprises establishing said vector from data rates previously used by said modem pairs.

5. A method according to claim 2 wherein said establishing step comprises:
measuring wire attenuation for any of said modem pairs; and
interpolating said corresponding data rate from said wire attenuation using heuristics.

6. A method according to claim 2 wherein said establishing step comprises:
measuring SNR for any of said modem pairs; and
interpolating said corresponding data rate from said SNR using heuristics.

7. A method according to claim I wherein said performing step b) comprises incrementing an iteration counter and wherein said termination condition is met when said iteration counter reaches an iteration limit.

8. A method according to claim 1 wherein said performing step b) comprises performing until an elapsed time limit is reached.

9. A method according to claim 1 wherein said performing step b) comprises performing until there is no change in said data rates from a previous iteration of step b).

10. A method according to claim 1 and further comprising adjusting said highest data rate for any of said modem pairs according to the formula
$${Rate}_{Corrected} = {Rate}_{max} - StabilityFactor * \frac{{SNR}_{Re f} - SNR}{{SNR}_{Re f}}$$
where Rate_{Max} is said highest data rate, StabilityFactor is any factor for step adjustment, SNR is the measured SNR of said modem pair, and SNR_{Ref} is any SNR value.

11. A method according to claim 10 wherein said adjusting step comprises using the minimum SNR of said modem pair where the SNR differs for each of said modems in said modem pair.

12. A method of parallel data rate setting in first and second modem pools, each modem pool including a plurality of modems, where each modem in one of said modem pools is paired with a corresponding modem in the other of said modem pools, the method comprising the steps of:
a) establishing a vector of initial data rates, wherein each of said data rates corresponds to a different one of said modem pairs;
b) setting substantially in parallel each of said modem pairs to said modem pair's corresponding data rate in said vector;
c) setting a lower rate for each of said modem pairs that is less than or equal to said modem pair's initial data rate;
d) setting an upper rate for each of said modem pairs that is greater than or equal to said modem pair's initial data rate;
for each of said modem pairs:
e) performing the following steps f)—j) one or more times until a termination condition is met:
f) if said modem pair is synchronized within a synchronization time period:
g) setting a lower rate for said modem pair equal to the current data rate of said modem pair; and
h) setting a maximum rate for said modem pair equal to the current data rate of said modem pair;
i) if said modem pair is not synchronized within said synchronization time period, setting a higher rate for said modem pair equal to the current data rate of said modem pair;
j) setting said modem pair's corresponding data rate in said vector to between said lower rate and said higher rate; and
k) setting each of said modem pairs to said modem pair's maximum rate where said modem pair achieved synchronization at said maximum rate.

13. A method according to claim 12 wherein said establishing step comprises establishing said vector at one of said modem pools and communicating said vector to the other of said modem pools.

14. A method according to claim 12 wherein said establishing step comprises establishing said vector from data rates previously used by said modem pairs.

15. A method according to claim 12 wherein said establishing step comprises:
measuring wire attenuation for any of said modem pairs; and
interpolating said corresponding data rate from said wire attenuation using heuristics.

16. A method according to claim 12 wherein said establishing step comprises:
measuring SNR for any of said modem pairs; and
interpolating said corresponding data rate from said SNR using heuristics.

17. A method according to claim 12 wherein said performing step e) comprises incrementing an iteration counter and wherein said termination condition is met when said iteration counter reaches an iteration limit.

18. A method according to claim 12 wherein said performing step e) comprises performing until an elapsed time limit is reached.

19. A method according to claim 12 wherein said performing step e) comprises performing until there is no change in said data rates from a previous iteration of step e).

20. A method according to claim 12 and further comprising adjusting said highest data rate for any of said modem pairs according to the formula
$${Rate}_{Corrected} = {Rate}_{max} - StabilityFactor * \frac{{SNR}_{Re f} - SNR}{{SNR}_{Re f}}$$
where Rate_{Max} is said highest data rate, StabilityFactor is any factor for step adjustment, SNR is the measured SNR of said modem pair, and SNR_{Ref} is any SNR value.

21. A data communications system comprising:
a first and a second modem pool, each modem pool including a plurality of modems, where each modem in one of said modem pools is paired with a corresponding modem in the other of said modem pools; and
a parallel data rate setter operative to:
a) set substantially in parallel each of said modem pairs to an initial data rate;
for each of said modem pairs:
b) perform the following steps c) - d) one or more times until a termination condition is met:
c) if said modem pair is synchronized within a synchronization time period, increase said modem pair's data rate;
d) if said modem pair is not synchronized within said synchronization time period, decrease said modem pair's data rate; and
e) set each of said modem pairs to the highest data rate at which said modem pair achieved synchronization.

22. A system according to claim 21 wherein said parallel data rate setter is additionally operative to establish a vector of initial data rates, wherein each of said data rates corresponds to a different one of said modem pairs, and set each of said modem pairs to its corresponding initial data rate in said vector.

23. A system according to claim 22 wherein said parallel data rate setter is additionally operative to establish said vector at one of said modem pools and communicate said vector to the other of said modem pools.

24. A system according to claim 22 wherein said parallel data rate setter is additionally operative to establish said vector from data rates previously used by said modem pairs.

25. A system according to claim 22 wherein said parallel data rate setter is additionally operative to:
measure wire attenuation for any of said modem pairs; and
interpolate said corresponding data rate from said wire attenuation using heuristics.

26. A system according to claim 22 wherein said parallel data rate setter is additionally operative to:
measure SNR for any of said modem pairs; and
interpolate said corresponding data rate from said SNR using heuristics.

27. A system according to claim 21 wherein said parallel data rate setter is additionally operative to increment an iteration counter and wherein said termination condition is met when said iteration counter reaches an iteration limit.

28. A system according to claim 21 wherein said parallel data rate setter is additionally operative to perform step b) until an elapsed time limit is reached.

29. A system according to claim 21 wherein said parallel data rate setter is additionally operative to perform step b) until there is no change in said data rates from a previous iteration of step b).

30. A system according to claim 21 wherein said parallel data rate setter is additionally operative to adjust said highest data rate for any of said modem pairs according to the formula
$${Rate}_{Corrected} = {Rate}_{Max} - StabilityFactor * \frac{{SNR}_{Ref} - SNR}{{SNR}_{Ref}}$$
where Rate_{Max} is said highest data rate, StabilityFactor is any factor for step adjustment, SNR is the measured SNR of said modem pair, and SNR_{Ref} is any SNR value.

31. A system according to claim 30 wherein said parallel data rate setter is additionally operative to adjust using the minimum SNR of said modem pair where the SNR differs for each of said modems in said modem pair.

32. A data communications system comprising:
a first and a second modem pool, each modem pool including a plurality of modems, where each modem in one of said modem pools is paired with a corresponding modem in the other of said modem pools; and
a parallel data rate setter operative to:
a) establish a vector of initial data rates, wherein each of said data rates corresponds to a different one of said modem pairs;
b) set substantially in parallel each of said modem pairs to said modem pair's corresponding data rate in said vector;
c) set a lower rate for each of said modem pairs that is less than or equal to said modem pair's initial data rate;
d) set an upper rate for each of said modem pairs that is greater than or equal to said modem pair's initial data rate;
for each of said modem pairs:
e) perform the following steps f)—j) one or more times until a termination condition is met:
f) if said modem pair is synchronized within a synchronization time period:
g) set a lower rate for said modem pair equal to the current data rate of said modem pair; and
h) set a maximum rate for said modem pair equal to the current data rate of said modem pair;
i) if said modem pair is not synchronized within said synchronization time period, set a higher rate for said modem pair equal to the current data rate of said modem pair;
j) set said modem pair's corresponding data rate in said vector to between said lower rate and said higher rate; and
k) set each of said modem pairs to said modem pair's maximum rate where said modem pair achieved synchronization at said maximum rate.

33. A system according to claim 32 wherein said parallel data rate setter is additionally operative to establish said vector at one of said modem pools and communicate said vector to the other of said modem pools.

34. A system according to claim 32 wherein said parallel data rate setter is additionally operative to establish said vector from data rates previously used by said modem pairs.

35. A system according to claim 32 wherein said parallel data rate setter is additionally operative to:
measure wire attenuation for any of said modem pairs; and
interpolate said corresponding data rate from said wire attenuation using heuristics.

36. A system according to claim 32 wherein said parallel data rate setter is additionally operative to:
measure SNR for any of said modem pairs; and
interpolate said corresponding data rate from said SNR using heuristics.

37. A system according to claim 32 wherein said parallel data rate setter is additionally operative to increment an iteration counter and wherein said termination condition is met when said iteration counter reaches an iteration limit.

38. A system according to claim 32 wherein said parallel data rate setter is additionally operative to perform step e) until an elapsed time limit is reached.

39. A system according to claim 32 wherein said parallel data rate setter is additionally operative to perform step e) until there is no change in said data rates from a previous iteration of step e).

40. A system according to claim 32 wherein said parallel data rate setter is additionally operative to adjust s aid highest data rate for any of said modem pairs according to the formula
$${Rate}_{Corrected} = {Rate}_{Max} - StabilityFactor * \frac{{SNR}_{Ref} - SNR}{{SNR}_{Ref}}$$
where Rate_{Max} is said highest data rate, StabilityFactor is any factor for step adjustment, SNR is the measured SNR of said modem pair, and SNR_{Ref} is any SNR value.
